(19) United States
(12) Patent Application Publication
(10) Pub. No.: US 2013/0324075 A1
(43) Pub. Date: Dec. 5, 2013

(54) Data Loading Control

(71) Applicant: Nokia Siemens Networks Oy, Espoo (FI)

(72) Inventors: Anatoly Andrianov, Schaumburg, IL (US); John M. Harris, Glenview, IL (US); Sean Kelley, Hoffman Estates, IL (US)

(21) Appl. No.: 13/908,524

(22) Filed: Jun. 3, 2013

Related U.S. Application Data
(60) Provisional application No. 61/655,688, filed on Jun. 5, 2012.

(51) Int. Cl. H04W 24/00

(52) U.S. Cl. CPC H04W 24/00
USPC 455/405; 455/414.2; 455/414.3

(57) ABSTRACT

Systems and techniques for managing delivery of data to a device are described. Conditions are analyzed relating to delivery of data to a wireless communication device and, based on the analysis, needed adjustments are made to data delivery, such as pre-delivering data before it is needed. The analysis may include analysis of channel conditions and estimates of user behavior, such as stopping consumption of data—as in the case of a user watching a video and abandoning the video before it is finished.

### CROSS-REFERENCE TO RELATED APPLICATIONS

This patent application claims priority under 35 U.S.C. 119(e) from Provisional Patent Application No. 61/655,688, filed on 5 Jun. 2012, the disclosure oft which is incorporated by reference herein in its entirety.

### TECHNICAL FIELD

The exemplary and non-limiting embodiments of this invention relate generally to wireless communications and more specifically to controlling retrieval of data, such as video data, by user equipment from a wireless network while the data is used by the user equipment.

### BACKGROUND

The following abbreviations that may be found in the specification and/or the drawing figures are defined as follows:
3GPP Third Generation Partnership Project
CDMA Code Division Multiple Access
CAN Content Aware Network
CAN-EG Content Aware Network-Enabling Gateway
CDN Content Distribution Network
C-SON Centralized Self Optimizing Network
DL Downlink
E-UTRA Evolved Universal Terrestrial Radio Access
eNB or eNodeB Evolved Node B/Base Station in an E-UTRAN System
EPC Enhanced Packet Core
E-UTRAN Evolved UTRAN (LTE)
FDD Frequency Division Duplex
FDM Frequency Division Multiplexing
GPS Global Positioning System
GSM Global System for Mobile Communications
GPRS General Packet Radio Service
GTP GPRS tunneling protocol
HetNET Heterogeneous Network
HO Handoff
IP Internet Protocol
IRP Interface Reference Point
LTE Long Term Evolution
LTE-A Long Term Evolution Advanced
MAC Medium Access Control
MDT Minimization of Drive Tests
MME Mobility Management Entity
MO Media Optimizer
MR Measurement Report
PCRF Policy and Charging Rule Function
PDN-GW Packet Data Network Gateway
QAM Quadrature Amplitude Modulation
QPSK Quadrature (Quaternary) Phase Shift Keying
RRC Radio Resource Control
RAN Radio Access Network
RF Radio Frequency
Rx Reception
SGW Serving Gateway
SON Self Optimizing Network
TDD Time Division Duplex
TDM Time Division Multiplexing
Tx Transmittance
UCI Uplink Control information
UE User Equipment (e.g. mobile terminal)
UL Uplink
UMTS Universal Mobile Telecommunications System
UTRAN Universal Terrestrial Radio Access Network

The use of mobile wireless devices for receiving data is gaining in importance, and the delivery of video data is consuming a larger and larger share of available wireless capacity, both because of its popularity and because video applications inherently consume relatively great amounts of data. In the case of video data, various techniques such as media optimization and adaptive streaming servers promise to significantly increase system capacity and video quality in wireless networks such as 3GPP LTE networks. For example, media optimizer and adaptive streaming servers can manage downloading of video to user equipment, such as a camera phone, smart phone, tablet computer, media play with wireless capability, or the like, just in time to be played. Such an approach avoids waste of resources when a user abandons a video before it is complete, because it avoids transferring data that will never be used. However, a user may frequently be expected to experience a gap in coverage or impaired coverage, so that under some circumstances video will be not be available at the moment it is needed. Delivering data before it is needed, which may be referred to as pre-filling data, will avoid interruption or degradation of video quality. This discussion will be presented primarily in terms of video data, but it will be recognized that the mechanisms described here may be applied to any circumstances in which data is typically delivered as needed in order to use transmission capacity efficiently, but in which conditions are evaluated to determine whether data should be delivered before it is immediately needed.

The need for pre-filling of data will vary based on the particular circumstances of a UE. In addition, turning to the example of video data, much video data is configured so as to be playable only by a single UE, as in the case in which video is encrypted with a key provided only to a single UE or a few UEs, or in the case in which digital rights management (DRM) is used, so that video is configured to be transferable only to a single UE.

If video data is to be reliably delivered, however, accommodations must be made for areas experiencing poor coverage or significant loads, interfering with the ability of a UE to receive data just in time for playback. Under such circumstances, it is desirable for the UE to receive data during times when it may be efficiently delivered, so that the data will be available for playback during a period of slow or no delivery.

### SUMMARY

In one embodiment of the invention, an apparatus comprises at east one processor and memory storing computer program code. The memory storing the computer program code is configured to, with the at least one processor, cause the apparatus to at least analyze conditions affecting a wireless communication device receiving data from a data communications network and, based on the analysis of the conditions, determine needed adjustments to delivery of the data to the wireless communication device.

In another embodiment of the invention, a method comprises analyzing conditions affecting a wireless communication device receiving data from a data communications network and, based on the analysis of the conditions, determining needed adjustments to delivery of the data to the wireless communication device.

In another embodiment of the invention, a computer readable medium stores a program of instructions, execution of which by a processor configures an apparatus to at least analyze conditions affecting a wireless communication device receiving data from a data communications network and, based on the analysis of the conditions, determine needed adjustments to delivery of the data to the wireless communication device.

These and other embodiments of the invention are described below with particularity.

### BRIEF DESCRIPTION OF THE DRAWINGS

For a better understanding of the nature and objects of the present invention, reference is made to the following detailed description taken in conjunction with the following drawings, in which:

FIG. 1 illustrates an exemplary wireless communication system according to an embodiment of the present invention;

FIG. 2 illustrates network elements according to an embodiment of the present invention; and

FIG. 3 illustrates a process according to an embodiment of the present invention.

### DETAILED DESCRIPTION

A new method, apparatus, and software related product, such as a computer readable medium, are presented for controlling pre-filling of video data to a user equipment by a wireless network for playback by the user equipment. It is noted that in the following, for the purpose of this invention, the term “video data” may be equivalent to “video clips”, “video”, “video/audio data”, “media”, “media data”, “video and audio data” or “audio data”. It will be recognized that while the network provides data, the decisions for when data is to be requested are generally made by the UE, and one or more embodiments of the present invention provide mechanisms to deliver predictions and other information to the UE that the UE may use to determine when pre-filling of data should be requested. The UE may determine when to request pre-filling of information based on the predictions and other information received from the network.

In an exemplary embodiment, a macro network such as a third generation preferred partnership (3GPP) long term evolution (LTE) network may comprise a content aware network (CAN) gateway. Such a gateway may, for example create a content aware network enabling gateway (CAN-EG.) The network may also comprise a media optimizer or content servers, evolved Node B (eNB) and other network entities of the radio access network or the core network. It is also noted that the term eNB is commonly applied to LTE networks. However, the exemplary embodiments are not limited to LTE and may be applied to other radio access technologies such as GSM/UMTS (global system for mobile communications/universal mobile telecommunications system), CDMA (code division multiple access) and LTE-A (LTE-advanced).

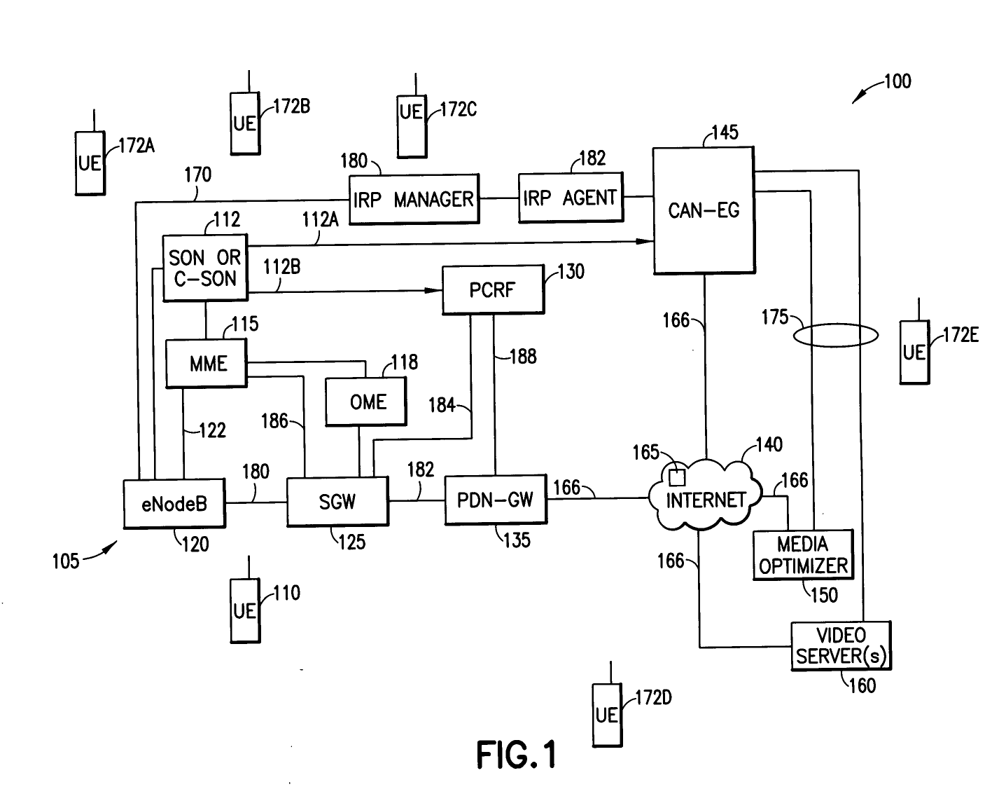

FIG. 1 illustrates a block diagram of an exemplary system comprising elements and using techniques according to one or more embodiments of the present invention. FIG. 1 presents an example of a video server-radio access network (RAN) interfaced architecture for a macro cell. The architecture shows a user equipment 110 communicating via a wireless connection 105 (including uplink and downlink) to a network 100. The network 100 includes an eNode B 120, a (centralized) self optimizing network (SON or C-SON) server 112, a serving gateway (SGW) 125, a mobility management entity (MME) 115, an operations and management entity 118, a policy and charging rules function (PCRF) network element 130, a packet data network gateway (PDN-GW) 135, a content aware network-enabling gateway (CAN-EG) 145, a media optimizer 150, and video server(s) 160. The network 100 is coupled to the Internet 140 and in particular to a content source 165 in the Internet 140. The self-optimizing network is connected to the CAN-EG 145 using an interface 112A and to the PCRF element 130 using an interface 112B.

The eNodeB 120 is connected to the SGW 125. The connection may be accomplished, for example, by an S1-U interface 181. The SGW 125 is connected to the PDN-GW 135, for example, by an S5/S8 interface 182. The SGW 125 is also connected to the PCRF 130, for example, by a Gxx/Gxa interface 184. The SGW 125 is further connected to the MME 115 for example, by an S11 interface 186. The PDN-GW 35 is connected to the PCRF 130, for example, by a Gx interface 188. The Internet 140 is connected to the CAN-EG 145, the media optimizer 150, the video server(s) 160, and the PDN-GW 135 via multiple networks 166 implementing at least internet protocol (IP) interfaces. A network 175 implements, for example, a diameter protocol (providing, for example an authentication, authorization and accounting (AAA) framework) over a stream control transmission protocol (SCTP) and a transport layer protocol. A network 170 between the CAN-EG and the eNodeB 120 may implement a GTP-U interface. GTP-U is a GPRS tunneling protocol user plane. As is known, GTP-U protocol is used over S1-U, X2, S4, S5, and S8 interfaces of the Evolved Packet System (EPS). The network 100 may also include an Interface Reference Point (IRP) manager 180 and an IRP agent 182. The IRP manager 180 will be able to control self-optimization functions, and the IRP agent 182 will provide for a capability for the IRP manager to know the success or failure of self-optimization functions.

It is noted that the entities in the network 100 are merely exemplary, and there may be different, fewer, or more entities. Also network elements shown in FIG. 1 may be located in different parts of the network. Furthermore, the various networks and the corresponding implementation of interfaces and/or protocols are also merely exemplary. It should also be noted the elements of the “radio access network” (RAN) are radio access technology (RAT) specific. For instance, in LTE, network is defined as EUTRAN/EPC (Enhanced UTRAN/Enhanced Packet Core). The eNodeB may be the only component of the RAN/EUTRAN, whereas the MME, SON (or C-SON), SGW, PDN-GW, PCRF may be parts of the EPC. In UMTS, the Node B and the RNC (radio network controller) are part of the RAN while the SSGN, GGSN, PCRF are part of the core.

In this example, the UE 110 may connect to the content source 165 in the Internet 140 to download video via the media optimizer 150. Optimized content is streamed from the media optimizer 150 or video server 160 to the PDN-GW 135 which forwards the content to the SGW 125 and finally through the eNodeB 120 to the UE 110. The CAN-EG may allow the video server 160 and media optimizer 150 to establish and modify the bearer characteristics between the PDN-GW 135 and the UE 110 by making the requests via the CAN-EG 145. The CAN-EG 145 may also collect network metrics from the eNodeB 120 and other network elements and report these to the media optimizer 150 and video server 60. Additionally the media optimizer 150 and video servers 160 may communicate with the eNodeB 120 using the network 170 via the CAN-EG. The video server(s) 60 in this example act to cache video from the content source(s) 165. As such, the video server(s) 160 may be considered surrogate servers, since these servers 160 contain cached copies of the videos in the content source 165.

Also “small” cell architectures, such as pico or femto cells (e.g., for LTE-A) may be used for practicing exemplary embodiments of the invention, using, for instance, “zone” eNB (ZeNB) controller (controlling multiple eNBs) and content delivery network (CDN) surrogate.

In one embodiment of the invention an SON algorithm residing on at least one network element, such as a C-SON server, Node B or eNB, or MME of a wireless network such as the wireless network 100 of FIG. 1 may monitor and determine conditions affecting a UE when the UE is receiving and playing video data. Conditions may be associated with or may affect an information capacity, load, or throughput, of a communication channel, or with a cost of transmitting information from an application through the wireless network to the UE. Such a cost may depend on factors such as the modulation scheme being used, and may be expressed, for example, in terms of cost per bit of information.

The wireless network 100 serves a plurality of UEs such as the UE 110, which will be discussed here as an exemplary UE receiving video data, and the UEs 172A-172E, which are also receiving network services and whose use of resources affects the resources available to the UE 110. The UEs 110 and 172A-172E may have different relationships to the network 100, such as different guaranteed service levels, and may also experience conditions and events that change over time and that differ among the different UEs. The wireless network 100 may implement a policy administered by the operations and management entity (OME) 118, the IRP manager 180, and the IRP agent 182. The IRP agent 180 may support the capability for the IRP manager to define policy directions in case self-optimizing network functions request conflicting parameter values. If no policy directions are given, the IRP agent may apply default policy directions.

A policy direction describes an expected behavior from the IRP agent 182. Examples for such policy directions include prioritizing SON functions in case of conflicts, prohibiting further changes of a parameter for a specific amount of time, selecting preferred value ranges, or directing the IRP agent 182 to report conflicts. If the IRP agent 182 does not resolve the case in which SON functions request conflicting values for parameters, the IRP agent 182 allows for a capability for the IRP manager 182 to determine parameter values.

The IRP agent 182 may support a capability allowing the IRP manager 180 to configure the SON coordination policy. The coordination includes coordination between different self-optimizing functions and coordination between different targets within one self-optimizing function.

The policy may define the conditions that are taken into account when making predictions and the UEs to which predictions are delivered. If a prediction causes video data to be delivered to a UE for pre-filling, the making of the prediction and its delivery to the UE and the UE's subsequent action in response to the prediction may have a significant impact on the availability of resources to other UEs.

Therefore, mechanisms according to one or more embodiments of the present invention define the conditions under which a prediction relating to pre-filling of data should be delivered to a UE and mechanisms for such delivery. In addition, one or more embodiments of the present invention define mechanisms for the UE to interpret and act on such predictions.

A number of factors taken into account in making predictions may have to do with factors such as the quality of service to which the UE is entitled, the likelihood that the particular UE in question will encounter degraded conditions that will impair timely delivery of data, or that the UE will encounter above-average conditions so that it can receive buffered data without excessive impact on others. The predictions may vary based on the time period taken into account, and the time for which the predicted events or conditions are expected to last. Predictions may be made based at least in part on specific network rules for self-optimization. Predictions may be made at the level of the network as a whole, at a cell, taking into account both conditions in the macro cell and in overlapping smaller cells such as micro and pico cells, and the performance of a specific eNodeB, and the conditions affecting its operation.

In one or more embodiments of the invention, the eNB 120 may perform its own measurements and receive measurements from UEs such as a UE that is receiving or will receive video data. In the present example, this may be the UE 110. The eNB 120 may also receive measurements from other UEs in the environment, such as the UEs 172A-172E. Appropriate network elements analyze the measurements and make predictions based, for example on service levels. A service level involves factors such as a rate and quality of data delivery that can be provided to the UE 110. Predictions relating to changes in service, which may constitute either degradations or improvements in service, are communicated to a UE that is receiving or will receive video data. In the present example this may be the UE 110.

For example, a network element may determine based on measurements made by the UE 110, that the UE is approaching a coverage hole. A coverage hole may be defined as an area of significantly diminished coverage relative to the network average. The network element may determine that the UE should pre-fill data while still in an area of greater coverage, based at least in part on a cost calculation in which communication in an area of low coverage is assigned a higher cost than in an area of higher coverage. Similarly, areas or times of high network loading may be assigned a higher cost than areas or times of low network loading, and a network element may determine that the UE should pre-fill data while in an area of low network loading or at a time of low network loading. Numerous other factors influencing decisions relating to the desirability of pre-filling data by the UE may be taken into account, exemplary ones of which are discussed below.

The network 100 delivers information that can be interpreted by the UE as indicating a need to pre-fill data or otherwise take steps to maintain the quality of the user's experience. Upon receiving the information, which may include predictions of impairment or explicit indications that data should be pre-filled, the UE makes the information available to mobile applications through an application programming interface.

One or more network elements may be used to make predictions that can be used to determine when a UE should request data. Such predictions may be specific to a particular UE, and may depend, for example, on the status of a UE. Various specific network entities may enter into the decisions relating to how the predictions are made and communicated. For example, the network may use or create specific controls, targets, or key performance indicators determining specific characteristics of the predictions that are to be made. Such predictions may be provided to specific UEs based on determinations made by appropriate network elements. For example, the operations and management entity (OME) 118 may set a policy controlling which predictors are disclosed to which UEs.

For example, if a UE is entitled to an elevated level of service, more network resources may be dedicated to delivering video data to the UE, so that the prediction increases the likelihood that the UE will receive data before it is needed. Predictions may also take into account specific events associated with particular UEs, such as movement of the UE toward a location providing poor coverage or, on the other hand, movement of a UE into or out of a location providing unusually good coverage.

The desirability of pre-filling video may be evaluated based on expected communication costs, with the cost being expressed in terms of the communications resources needed to deliver the video. If the UE 110 is in an area of good coverage, pre-delivering video, even if that video is abandoned, may be less costly than delivering video just in time for playback.

Predictions may include or be based on a number of factors or events. Factors may include anticipated call drop, which may be based on radiofrequency conditions, measurements, UE reports, and the like. Another factor ma include anticipated quality of service degradation, that is, that the network is unable to support the UEs required quality of service in terms of throughput, time budget, or similar parameters. Possible events may be energy savings events, such as cell shutdown, or anticipated handover, which might be inter-radio access technology (iRAT) or other similar events, leading to temporary degradation.

In a distributed self-optimizing network such as the network 100, the IRP agent 182 may support a capability for the IRP manager 180 to define the UE notification policy by SON functions, where an SON function may predict a service degradation or improvement affecting a UE such as the UE 110. The policy may include specific event types, might provide targets, key performance indicators (KPIs) and thresholds, controls, and the like. The policy may also include a specific depth of prediction, expressed in terms of time, and specific self-optimizing network functions. The policy may also include an architectural level of prediction, such as the eNodeB, cell, or other level of prediction, and may designate specific UE groups, for example, based on quality of service level.

For centralized or hybrid SON, OME and C-SON servers, and the IRP manager 180 and IRP agent 182 might provide higher level or higher scale predictions, such as energy savings, cell or system boundaries, and the like. In one or more embodiments of the invention, the predictions are provided as part of a premium service, such as a general higher level of service or a specific service directed to providing and acting on predictions so as to prevent interruption of a user's video.

Once the UE has determined that a service degradation is expected or that, for other reasons, it should take actions to maintain the quality of the user's experience or to minimize transmission costs, it can take any of a number of actions. One possible action is pre-filling video or audio data while still experiencing satisfactory or better than usual conditions. Another possible action that can be taken is to postpone activities requiring heavy data usage until poor conditions have ended. One condition under which such an action may be particularly appropriate is during or on the threshold of a handover. The UE can be expected to be at the edge of a cell, and may expect to experience better conditions while in its new cell.

An appropriate network element, such as the operations and management entity 118, may prepare a message for the UE 110 indicating that the UE should pre-fill data. The message may include information such as estimated time until impairment, estimated duration of impairment, or other relevant information. The amount of pre-fill will be influenced by the amount of video watched so far, and the probability of abandonment will also change depending on the amount of video watched. Another factor may be the setup and loading time, because if a user has waited through a longer setup time, he or she will be more likely to watch the video all the wax through. Another factor that may be taken into account includes abandonment history for a particular user. If a user has a history of abandoning videos after a short time, the likelihood that the UE will need to pre-fill data can be substantially reduced by comparison to users that tend to watch videos to the end.

A radio access network predicts an impairment of the air interface and the UE 110 is notified of the prediction, such as by an eNodeB. The prediction may come in the form of a message including information such as an estimated time until the impairment, the estimated duration of the impairment, and other related information. As an example, the message can be a radio resource control message, and the UE passes the indication, as well as any additional information included in or with the indication, to upper layers for handling.

In one example of the operation of a network such as the network 100, the following assumptions may be made:

Cell radius—0.6 km

Cell to cell distance—approximately 1 km.

Mobility model
30% “mobile users” (traveling at >30 kmph)
70% “static users” (traveling at <30 kmph)

Number of access attempts overall (all users in all RF conditions) N

Cost of initiating a service: Y information bits

Modulation: QPSK and QAM

QPSK—“bad” RF

QAM—“good” RF

“bad RF”—QPSK—average symbols/information bit=1.9

“good RF”—QAM—average symbols/information bit=0.4

Pre-filling video allows for the carrying of services in good RF conditions, when without pre-filling, such services would be carried in bad RF conditions. For example, assume that an average “mobile” user, currently in good RF conditions, will be in bad RF conditions within approximately the next two minutes or less, which is the time required to travel 1 km at 30 kmph. If 30% of the users are mobile users, then allowing pre-filling of video allows for 30% of services to be carried under good RF conditions, that would otherwise be carried under bad RF conditions.

Defining differences in terms of an RF cost of access attempts, then the cost of access attempts without pre-filing is:

(N/3*0.4Y)+(2N/3*1.9Y)=1.4*N*Y.

The costs of access attempts with pre-filing allowed is:

(N/3*0.4Y)+(0.3*2N/3*0.4Y)+(0.7*2N/3*1.9Y)=1.1*N*Y.

Allowing pre-filling of data according to embodiments of the present invention thus allows for a 21% improvement.

In one or more embodiments of the present invention, evaluations may be conducted to determine when a UE such as the UE 110 is in an area of favorable coverage, such as in close proximity to an eNB or in a less loaded cell, that is, a cell with fewer user devices competing for resources provided by the eNB. Under such circumstances, pre-filling may be desirable because if the UE 110 is in an area of exceptionally favorable conditions, it is likely that the UE will shortly move to an area of less favorable coverage. This is true because if conditions are above average or well above average, any change is likely to lead to conditions nearer the average. Under these circumstances, the savings in cost is similar to that determined in the scenario above, and it will be recognized that differences in conditions, such as a different number of mobile versus static users, or a difference in the average symbols per information bit in bad RF versus good RF, will result in changes in the comparative costs.

An additional mechanism for improving a user's experience is compression of video in areas of poorer service. When a UE such as the UE 110 is expected to experience degradation of service, one response, which can be undertaken as an alternative or in addition to pre-filling data, is an increase in the compression of data. Compression of data may be performed by the eNB or other network elements before transmission, decreasing the transmission resources required. Effective compression of data such as video data is likely to require some loss of data, leading to a degradation in quality, so one approach is to increase compression only when the UE is in, or is expected to enter, a cell-edge area.

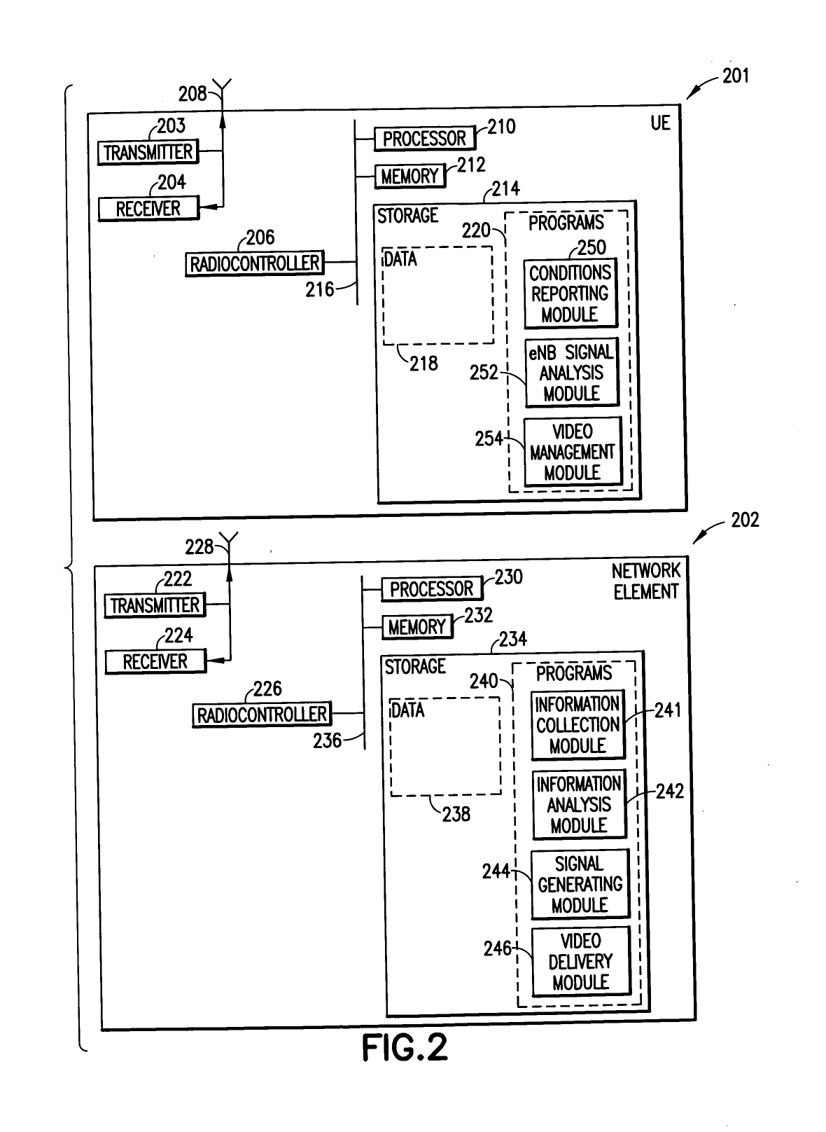

FIG. 2 illustrates details of a UE 201 and a network element, such as an LTE element, 202. The network element 202 may be a SON, C-SON, eNB, CAN-EG MME, OME, IRP agent, IRP manager, or other appropriate network element. The UE 201 comprises a transmitter 203, receiver 204, radiocontroller 206 and antenna 208. The UE 201 also includes a processor 210, memory 212, and storage 214, communicating with one another and with the radiocontroller 206 over a bus 216. The UE 201 employs data 218 and programs 220, suitably residing in storage 214 and transferred to memory 212 as needed for use by the processor 210. The network element 202 comprises a transmitter 222, receiver 224, radiocontroller 226 and antenna 228. The network element 202 also includes a processor 230, memory 232, and storage 234, communicating with one another and with the radiocontroller 226 over a bus 236. The network element 202 employs data 238 and programs 240, suitably residing in storage 234 and transferred to memory 232 as needed for use by the processor 230.

Among the programs 240 employed by the network element 202 comprise an information collection module 241 for monitoring conditions affecting a UE of interest, such as the UE 201 and an information analysis module 242, which may analyze information to make predictions relating to future conditions and determine if the UE should pre-fill data. The network element 202 also includes a signal generating module 244 for generating appropriate signals. The network element 202 includes a video delivery module 246, which responds to requests from the UE and delivers video data to fulfill the requests.

The UE 201 comprises a conditions reporting module 250, reporting channel conditions to the network element 202, as well as an eNB signal analysis module 252, which receives signals from the network element 202 such as signals indicating predictions that channel conditions will be impaired or simply that a UE should take steps to improve or maintain the user's video experience, such as by pre-filling data, compressing data, or pausing activities requiring heavy data use. The network element signal analysis module 252 examines the signals from the network element 202 and chooses an appropriate response. The UE 201 further comprises a video management module 254, which directs appropriate actions, such as requesting additional video data, increasing compression, pausing activities requiring a heavy data load, and so on. The video management module 254 manages receiving and playing of video data as needed to provide for a smooth video delivery to the user.

Various embodiments of the memory 212 and 232 and storage 214 and 234 may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 210 and 230 include but are not limited to general purpose computers, special purpose computers, microprocessors, digital signal processors (DSPs) and multi-core processors.

The various modules 242-246 and 250-254 may each be implemented as an application computer program stored, for example in the memory 212 and 232 and storage 214 and 234, but in general they may be implemented as software, firmware or hardware modules or a combination thereof. In particular, in the case of software or firmware, one embodiment may be implemented using a software related product such as a computer readable memory such as a non-transitory computer readable memory, computer readable medium or a computer readable storage structure comprising computer readable instructions such as program instructions using a computer program code. The computer program code may be, for example, the software or firmware) stored on the computer readable memory and may be thereon to be executed by a computer processor.

Furthermore, the modules 242-246 and 250-254 may be implemented as separate blocks or may be combined with any other modules or blocks of the module may be split into several blocks according to their functionality. Moreover, it is noted that all or selected modules of the module may be implemented using an integrated circuit by, for example, using an application specific integrated circuit, or ASIC.

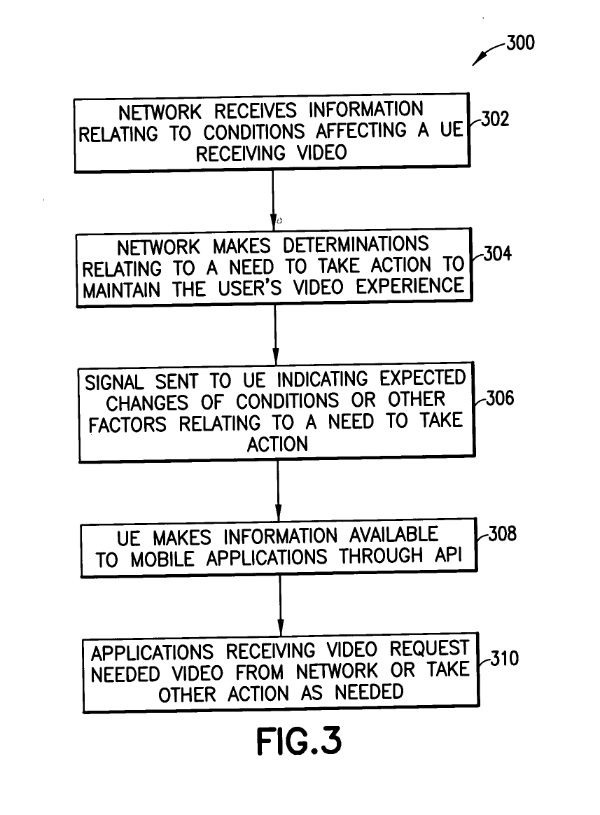

FIG. 3 illustrates a process 300 according to an embodiment of the present invention. It will be noted that the particular order of steps illustrated here is exemplary only and that steps may be skipped, different steps may be added or substituted, or selected steps or groups of steps may be performed in different processes. At step 302, elements of a network such as a self-optimizing network similar to the network 100 of FIG. 1 make and receive measurements relating to network conditions affecting at least one UE as the conditions affect the receiving of video data by the at least one UE. At step 304, network elements evaluate the conditions, taking into account factors such as coverage, the motion of the UE in question into an area of better service or worse service, demands by other UEs for resources, and other relevant factors. One or more network elements make determinations as to whether actions need to be taken to maintain the user's experience, such as by pre-fling video, compressing video, suspending applications presenting a higher demand for data, and the like. The determination may be made in part based on an expected likelihood that the user will abandon the video. At step 306, network elements signal the UE, providing the UE with an indication and relevant information as to whether there is a need to take action to maintain the user's video experience. At step 308, the UE makes information received in the signal available to mobile applications using video, suitably through an application programming interface. At step 310, applications request video data from the network for pre-tilling or take other action as needed.

An apparatus according to an embodiment of the invention analyzes conditions affecting a user equipment receiving data from a data communications network, analyzes the conditions to determine if the UE should take measures to maintain or improve data delivery, or to take advantage of favorable conditions, and sends information to the UE indicating if the UE should take such measures.

In one embodiment of the invention, the apparatus analyzes present conditions.

In one embodiment of the invention, the apparatus analyzes predicted conditions.

In one embodiment of the invention, the apparatus analyzes future conditions.

In one embodiment of the invention, the apparatus analyzes at least one of present, predicted, and future conditions.

In one embodiment of the invention, the data is video data.

In one embodiment of the invention, sending of information to the UE is performed according to a notification policy.

In one embodiment of the invention, the notification policy is defined by at least one self-optimizing network function.

In one embodiment of the invention, at least one self-optimizing network function predicts a service degradation affecting the UE.

In one embodiment of the invention, at least one self-optimizing network function predicts a service improvement affecting the UE.

In one embodiment of the invention, the policy defines at least one specific event type.

In one embodiment of the invention, the policy defines a performance of at least one action based on at least one target.

In one embodiment of the invention, the policy defines at least one key performance indicator.

In one embodiment of the invention, the policy defines at least one threshold.

In one embodiment of the invention, the policy defines at least one control.

In one embodiment of the invention, the policy includes a specific depth of prediction.

In one embodiment of the invention, the depth of prediction is expressed in terms of time.

In one embodiment of the invention, the policy is expressed in terms of at least one specific self-optimizing network function.

In one embodiment of the invention, the policy includes an architectural level of prediction.

In one embodiment of the invention, the policy designates at least one user equipment group.

In an apparatus according to one embodiment of the invention, the information is sent to the UE in the form of a signal.

In an apparatus according to one embodiment of the invention, maintaining data delivery by the user equipment comprises requesting data to be delivered before it is needed so that the data will be available during slow or interrupted service.

In an apparatus according to one embodiment of the invention, the data to be delivered is video data and the data is delivered before it is needed for playback.

In an apparatus according to one embodiment of the invention, maintaining data delivery by the user equipment comprises requesting data during favorable conditions.

In an apparatus according to an embodiment of the invention, analyzing conditions comprises determining if the user equipment is likely to encounter degraded service.

In an apparatus according to an embodiment of the invention, analyzing conditions comprises taking into account a likelihood that a user will abandon receiving the data.

In an apparatus according to an embodiment of the invention, the information comprises air interface signaling.

In an apparatus according to an embodiment of the invention, the information comprises a radio resource control message.

In an apparatus according to another embodiment of the invention, the information comprises a media access control message.

In an apparatus according to one embodiment of the invention, the information is delivered in an application layer.

In an apparatus according to one embodiment of the invention, the information is delivered in a network layer.

In an apparatus according to one embodiment of the invention, delivery of the information comprises using an application for delivery.

In an apparatus according to one embodiment of the invention, the information is received and processed using an application residing in the user equipment.

In one embodiment, the message comprises an indication that an air interface with the user equipment is expected to become impaired.

In another embodiment, the information relates to the impairment.

In another embodiment, the information comprises information relates to an estimated time until impairment.

In another embodiment, the apparatus selects a user equipment to receive the information based on a level of service to which the user equipment is entitled.

In another embodiment, the analysis takes into account anticipated quality of service degradation.

In another embodiment, the analysis takes into account anticipated handover.

In an embodiment of the invention, an apparatus receives a signal from a network element indicating a need to take measures to maintain delivery of data and responds to the signal by managing data retrieval from the network so as to continue delivery of data under conditions indicated by the signal.

In an embodiment of the invention, the apparatus responds to the signal by requesting the network to deliver data for pre-filling.

In an embodiment of the invention, the apparatus responds to the signal by requesting increased data compression.

In an embodiment of the invention, the apparatus responds to the signal by suspending activities of high data demand.

In an embodiment of the invention, the signal includes a prediction of degradation of channel conditions.

In an embodiment of the invention, the signal includes information indicating that the apparatus is experiencing favorable conditions.

In an embodiment of the invention, information relating to quality of channel conditions is based at least in part on a cost measurement.

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

1. An apparatus comprising:
at least one processor;
memory storing computer program code;
wherein the memory storing the computer program code is configured, with the at least one processor, to cause the apparatus to at least:
analyze conditions affecting a wireless communication device receiving data from a data communications network; and
based on the analysis of the conditions, determine needed adjustments to delivery of the data to the wireless communication device.

2. The apparatus of claim 1, wherein analyzing the conditions comprises estimating a rate of data delivery to the device and a rate of data consumption by the device and determining needed adjustments is based at least in part on comparing a delivery rate of data delivery against a rate of data consumption.

3. The apparatus of claim 2, wherein analyzing the conditions comprises estimating a future rate of data delivery to the device.

4. The apparatus of claim 2, wherein analyzing the conditions comprises estimating a future rate of data consumption by the device.

5. The apparatus of claim 4, wherein estimating the future rate of data consumption comprises estimating a likelihood that a user will abort consumption of a data stream by the device.

6. The apparatus of claim 1, wherein the apparatus is further caused to control the user device to request pre-delivery of data from a network to the user device.

7. The apparatus of claim 1, wherein analyzing conditions comprises analyzing conditions affecting performance of a network delivering the data to the device.

8. The apparatus of claim 3, wherein estimating a future rate of data delivery to the device comprises estimating channel degradation.

9-23. (canceled)

24. A method comprising:
analyzing conditions affecting a wireless communication device receiving data from a data communications network;
based on the analysis of the conditions, determining needed adjustments to delivery of the data to the wireless communication device.

25. The method of claim 24, wherein analyzing the conditions comprises estimating a rate of data delivery to the device and a rate of data consumption by the device and determining needed adjustments is based at least in part on comparing a delivery rate of data delivery against a rate of data consumption.

26. The method of claim 25, wherein analyzing the conditions comprises estimating a future rate of data delivery to the device.

27. The method of claim 25, wherein analyzing the conditions comprises estimating a future rate of data consumption by the device.

28. The method of claim 27, wherein estimating the future rate of data consumption comprises estimating a likelihood that a user will abort consumption of a data stream by the device.

29. The method of claim 24, wherein the apparatus is further caused to control the user device to request pre-delivery of data from a network to the user device.

30-46. (canceled)

47. A computer readable medium storing a program of instructions, execution of which by a processor configures an apparatus to at least:
analyze conditions affecting a wireless communication device receiving data from a data communications network; and
based on the analysis of the conditions, determine needed adjustments to delivery of the data to the wireless communication device.

48-62. (canceled)

63. The computer readable medium of claim 47, wherein the apparatus is further configured to send analysis information to the wireless communication device.

64. The computer readable medium of claim 63, wherein the analysis information comprises a radio resource control message.

65. The computer readable medium of claim 63, wherein the analysis information comprises a media access control message.

66. The computer readable medium of claim 47, wherein the memory storing the computer program code is further configured, with the at least one processor, to cause the apparatus to determine whether to send analysis information to the wireless communication device based on specified conditions.

67. The computer readable medium of claim 66, wherein the specified conditions are determined according to a policy.

68-69. (canceled)
